(19) United States
(12) Patent Application Publication
(10) Pub. No.: US 2006/0143134 A1
(43) Pub. Date: Jun. 29, 2006

(54) Method and apparatus for sharing a digital access license

(76) Inventors: Nicol So, Newtown, PA (US); George Lydecker, Burbank, CA (US)

Correspondence Address: Jack J'maev, Suite H, 187 W. Orangethorpe Ave., Placentia, CA, 92870, US

(21) Appl. No.: 11/024,248

(22) Filed: Dec. 25, 2004

(51) Int. Cl. G06F 17/60

(52) U.S. Cl. 705/59

(57) ABSTRACT

A method and apparatus for sharing a digital access license by receiving a request to share the license, identifying a current license to be shared, preparing a loaner-license according to the current license and conveying the loaner-license to a borrowing client.

### BACKGROUND

Ever since media entered the digital age, copyright owners have worried about the ease with which content can be shared. By this point in time, most of us are aware of just how easy it is to “rip” a compact disk (CD) or digital versatile disk (DVD). All of a sudden, one legitimate copy of copyrighted content can be used to spawn innumerable pirated copies. And worst of all, each copy will be just as robust in quality as the legitimate copy. The reason for this is that the digital copying process is, in essence, perfect. At least when pirated copies were made from analog media, copyright owners could relish in the fact that the pirated copies were never quite as good as the original.

Analog media was much more owner friendly because anti-copying mechanisms could be introduced into the recording themselves. Although these anti-copying mechanisms (e.g. the “Macrovision” system is one example) could be defeated, they could not be defeated without specialized hardware. Macrovision employs a technique known as synch-clipping where video synchronization pulses included in a video tape could be attenuated such that a television receiver could perceive the synchronization signals but a video recorder could not. As a result, a video pirate would need to introduce a specialized “black-box” in between the source video player and the copy recorder. Again, it was not so much that Macrovision could not be defeated, it was the fact that it was cumbersome and expensive to acquire and use the specialized hardware that made Macrovision much more effective than it otherwise would have been. It should be noted that Macrovision is often employed in DVD video disks, but it is even less effective here because a “DVD-ripper”, which is a software application tailored to steal video from a DVD disk, can easily recognize and overcome the Macrovision protection. Again, installing a DVD-ripper, which is typically available as a down from the Internet, on a personal computer is a great deal easier than buying an analog Macrovision “black box”.

In response to the ease with which media content can be defeated, the content industries (e.g. the music industry, the film industry and e-book publishers) have worked diligently to create digital rights management systems, which are typically known as DRM systems. By this point in time, there are literally a plethora of various DRM systems, the champions of each touting the efficacy of the protection afforded by their version of digital rights management.

To quickly summarize, essentially all DRM systems protect content through encryption. Encryption fulfills the basic requirement of any DRM system—to prevent access to the content unless it is specifically authorized. The various DRM systems known today differ in how they provide the authorized access to the encrypted content. For example, one DRM system provide a set of access rules, which are typically encoded into a content file. The access rules are used by a player (e.g. a CD or DVD disk) to determine if access is allowed. One example of an access rule is a region indicator, which indicates what geographic region in the world the content is authorized for.

More sophisticated DRM systems have also been conceived. For example, one system provides for a hardware token (e.g. an encoded integrated circuit chip) and a token reader. In order to gain access to content, the user must use a special presentation application that decrypts the content once a token has been properly recognized. What is important to realize is that there a wide variety of DRM systems, each of which claims to be the be-all to end-all DRM system.

The overall importance of DRM systems is growing every day. This is because many people now obtain their content through the Internet, or other form of electronic distribution. In this age of electronic distribution, an encrypted content file is provided to a user along with an access license. A specialized content player uses the license in order to decrypt the content and, once decrypted, present the content to a user. Typically, the access license is encoded with use-rules and other information that prevents the license from piracy. For example, an access license can be encoded with a hardware-specific platform identifier (e.g. a serial number of a personal media player) or user name. This can be done either when the license is granted or when the license is first used to play its associated content.

However, even the most sophisticated DRM systems sometimes have difficulty enabling certain types of usage that a content owner would like to permit. For example, when content was distributed on a physical medium, it was clearly possible to lend the medium to a friend or to sell the content second-hand. Once the medium was loaned out, the original owner of the content could no longer use the content because the act of loaning (or selling) the medium deprived the original owner to any further access to the content. In today's age of DRM, the owner of content simply can not lend or sell his content to any third party. This is because a license encoded with a hardware-specific platform identifier or user name will simply not work in any other environment.

### SUMMARY

A method and apparatus for sharing a digital access license by receiving a request to share the license, identifying a current license to be shared, preparing a loaner-license according to the current license and conveying the loaner-license to a borrowing client.

### BRIEF DESCRIPTION OF THE DRAWINGS

Several alternative embodiments will hereinafter be described in conjunction with the appended drawings and figures, wherein like numerals denote like elements, and in which:

FIG. 1 is a pictorial diagram that depicts various illustrative use cases for a method for sharing a digital access license;

FIG. 2 is a flow diagram that depicts one example method for sharing a digital access license;

FIG. 3 is a flow diagram that depicts alternative illustrative methods for receiving a request to share a digital access license;

FIG. 4 is a flow diagram that depicts alternative methods for receiving a request to share a digital license;

FIG. 5 illustrates one alternative method for receiving a request to share a license, where in the request is received from a local user;

FIG. 6 is a flow diagram that depicts one example alternative method for preparing a loaner-license;

FIG. 7 is a flow diagram that illustrates one alternative method for determining when a current license is shareable according to a share-limit;

FIG. 7A is a flow diagram that illustrates one alternative method for determining when a current license is shareable according to a share-depth;

FIG. 8 is a flow diagram that depicts alternative example variations of a method for preparing a loner license that includes a loner-limit indicator;

FIG. 9 is a flow diagram that depicts one example method for conveying a loaner-license to a borrowing client in an encrypted manner;

FIG. 10 is a flow diagram that depicts alternative methods for conveying a loaner-license to a borrowing client by means of an intermediary;

FIG. 11 is a block diagram that depicts several alternative example embodiments of an apparatus for sharing a digital access license;

FIG. 12 is a pictorial diagram that illustrates several example embodiments of a request for a loaner-license;

FIG. 13 is a pictorial diagram that illustrates several example embodiments of a digital access license; and

FIG. 14 is a data flow diagram that depicts the internal operation of several alternative embodiments of an apparatus for sharing a digital access license.

### DETAILED DESCRIPTION

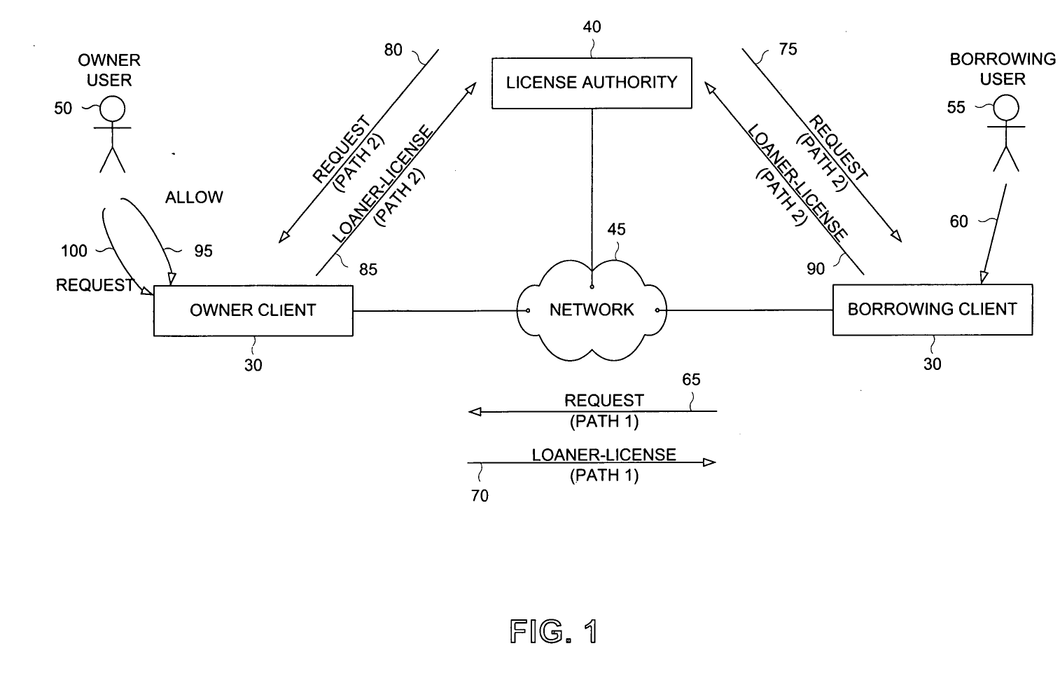

FIG. 1 is a pictorial diagram that depicts various illustrative use cases for a method for sharing a digital access license. The present method, as herein described, provides for sharing a digital access license. Accordingly, the present method can be applied in a situation where an owner user 50 controls an owner client 30. It should be appreciated that the owner client 30 comprises a platform upon which content may be enjoyed. For example, the platform upon which content may be enjoyed can include, but is not necessarily limited to a personal digital music device, a DVD player, a television (TV) receiver, a set-top-box (as used in direct satellite broadcast and cable TV), a personal computer that includes content presentation software (e.g. an “MP3” or “MPEG” player) and even a cellular telephone that is media aware. A different physical platform is generally used by a borrowing user 55 and can include the various platform categories already enumerated above. This second platform is known as a borrowing client 35. It should be appreciated that either the owner client 30 or the borrowing client 35 can include software that provides for the presentation of content to a user. This software, typically, interacts with specialized hardware in the platform to affect the presentation of the content to the user.

According to one illustrative use case, a borrowing user 55 can submit a request 60 to borrow a digital access license from the owner user 50. Accordingly, the request is received from the borrowing user 55 by the borrowing client 35. The borrowing client 35 can then direct the request 65 to the owner client 30. According to one illustrative use case, the owner client 30 will then make the owner user 50 aware of the incoming request. The owner user 50 can authorize the request by entering an allow indication 95 into the owner client 30. The owner client 30 can then prepare and deliver a loaner-license 70 back to the borrowing client 35. The request from the borrowing client 35 can, according to one illustrative use case, alternatively be directed to a license authority 40. This alternative request path 75 relies on the license authority 40 to propagate request 80 to the owner client 30. A loaner-license is then directed 85 to the license authority 40. The license authority 40 can then forward the loaner-license 90 to the borrowing client 35. In all of these illustrative use cases, communications are enabled by means of a numerous variety of physical interfaces, including, but not limited to an Ethernet interface, a serial interface (e.g. RS-232), a universal serial bus (a.k.a. USB), an infrared interface, a Bluetooth interface and a wireless networking interface (e.g. varied versions of IEEE 802.11).

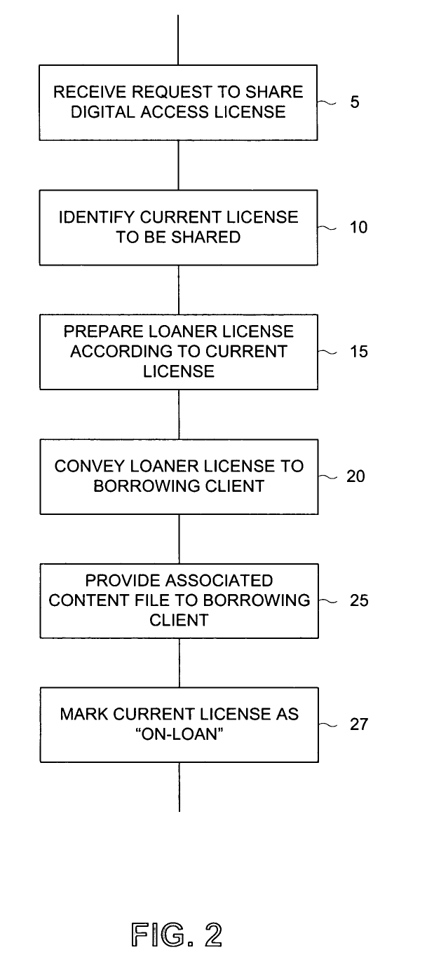

FIG. 2 is a flow diagram that depicts one example method for sharing a digital access license. According to this example method, sharing a digital access license is accomplished by receiving a request to share a digital access license (step 5). A current license to be shared is then identified (step 10). It should be appreciated that a license to be shared is typically associated with a media file. It should also be appreciated that a license to be shared, according to one illustrative use case, is included in the media file itself. According to another illustrative use case, the license to be shared is stored separately from the media file. In either case, the present method may be applied.

In order to share an access license, the present method provides for creating a loaner-license according to the current license (step 15). It should be appreciated that the loaner-license will typically include attributes pertaining to the current license to be shared. Once the loaner-license is prepared, it is conveyed to a borrowing client (step 20). According to one variation of the present method, conveyance to a borrowing client is accomplished by conveying the loaner-license directly to the borrowing client 35. According to yet another variation of the present method, conveyance to a borrowing client 35 is accomplished by directing the loaner-license to license authority 40, which then forwards the loaner-license to the borrowing client 35.

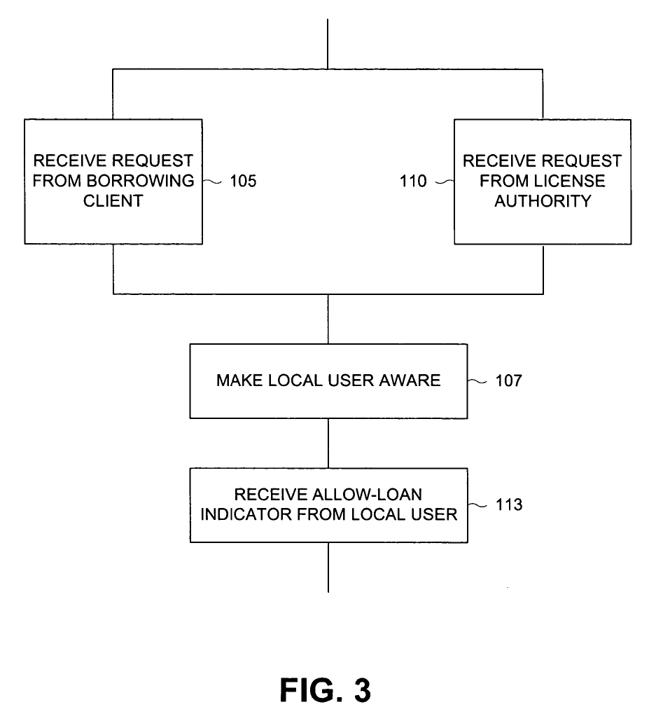

FIG. 3 is a flow diagram that depicts alternative illustrative methods for receiving a request to share a digital access license. When according to one example variation of the present method, when he request to share a digital access license is received by receiving a request from a borrowing client (step 105). This corresponds to the Path 1 request 65 depicted in FIG. 1. According to yet another illustrative variation of the present method, when a request to share a digital access license is received from a license authority (at 110). This corresponds to the Path 2 request path (75, 80). As already discussed, one illustrative use case relies on the license authority 40 to forward to an owner client 30 a request to share an access license received by the license authority 40 from a borrowing client 35. According to various example variation is of the present method, receiving a request either from the borrowing client directly or through an intermediary (e.g. license authority) is accomplished by means of an electronic message. For example, one variation of the present method provides for receiving an electronic-mail message and then to riding a request to borrow a digital access license according to the electronic-mail message. According to yet another example variation of the present method, a communications connection is established from the borrowing client 35 to the owner client 30. Such a communications connection, typically, is supported by a communications protocol. For example, one variation of the present method relies on the transmission control protocol/Internet protocol (TCP/IP) to govern the communications connection. It should further be appreciated that, where a communications connection is relied upon to receive a request to borrow a digital access license, and alternative variation of the present method provides for establishing a communications connection between the borrowing client 35 and the license authority 40. In this alternative variation, the borrowing client 35 conveys the request 75 to the license authority 40 by means of the communications connection established between the borrowing client 35 and the license authority 40. In this case, the license authority 40, acting as an intermediary, can either propagate the request directly to the owner client 30 or provide some other policing function in order to validate the request. In either case, the license authority 40 establishes a communications connection with the owner client 30 in order to direct 80 the request to the owner client 30.

According to one example alternative variation of the present method, a local user (e.g. the owner user 50) is made aware of a request to borrow a digital access license received by the owner client 30. The owner client 30, according to this variation of the present method, waits for the owner user 50 to indicate that the loan should be allowed. Accordingly, the owner client 30 receives as an allow-loan indicator from the owner user 50 and, in response, prepares a loaner-license and directs said loaner-license to the borrower client 35.

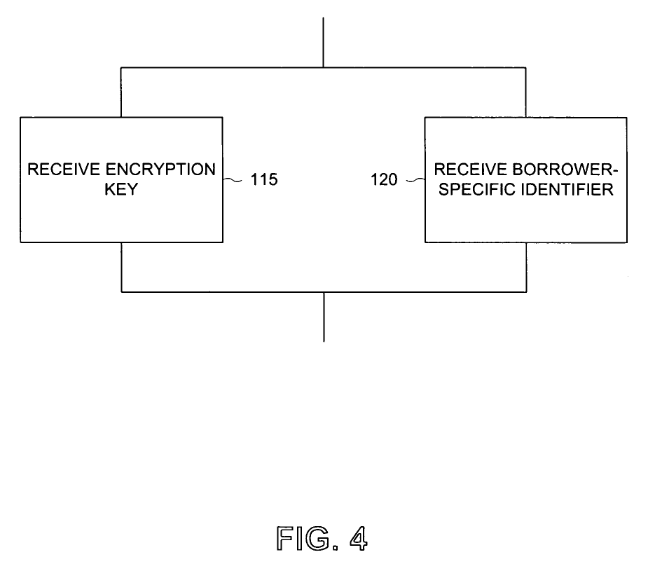

FIG. 4 is a flow diagram that depicts alternative methods for receiving a request to share a digital license. It should be appreciated that a digital loaner-license prepared in response to a request to borrow said license is typically vulnerable to compromise. Accordingly, the present method provides for at least two alternative variations wherein a loaner-license prepared in response to the request to share a digital license is secured. According to one variation of the present method, receiving a request to share a digital access license comprises receiving an encryption key (step 115). Typically, the encryption key comprises a public-key used in a private-key/public-key encryption scheme. Accordingly, the public-key is provided by the borrowing client 35 and is used to encrypt the loaner-license prior to conveying the loaner-license to the borrowing client 35. As such, the borrowing client 35 can use its private key to decrypt the encrypted loaner license. In yet another illustrative variation of the present method, receiving a request to share a digital access license comprises receiving a borrower-specific identifier (step 120). In this variation of the present method, the borrowing client 35 provides a borrower-specific identifier. Accordingly, a loaner-license is prepared in a manner wherein it may only be used on a presentation platform which is identified, or is otherwise associated with the borrower-specific identifier. The borrower-specific identifier, according to various alternative example variations of the present method comprises, but is not limited to one or more of a platform specific identifier, a hard drive volume identifier, a hardware token, a password and a user name. Any number of these may be used in various combinations. This list of example borrower-specific identifiers is presented herein in order to illustrate the present method and is not intended to limit the scope of the claims appended hereto.

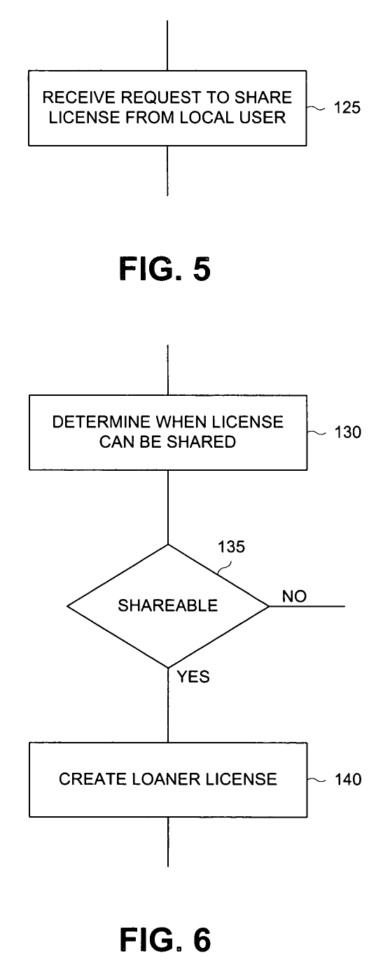

FIG. 5 illustrates one alternative method for receiving a request to share a license, where in the request is received from a local user. According to this alternative example method, he request to share a digital access license is received from a local user. For example, as depicted in FIG. 1, an owner user 50 and enter a request 100 into the owner client 30. In response, the owner client 30 will prepare a loaner-license to convey the loaner-license to a borrowing client 35. It should be appreciated that the request 100 provided by the owner user 50 will typically include identifier for the borrowing client 35. This alternative variation of the present method supports a used scenario wherein an owner user 50 can, at the owner user's own discretion, loan a digital access license to another user.

FIG. 6 is a flow diagram that depicts one example alternative method for preparing a loaner-license. It should be appreciated that a digital access license issued by a license authority 40 may not necessarily be “shareable”. In other words, the license authority 40, representing the interests of a copyright owner, may not allow a loaner-license to be prepared according to a current digital access license. As such, one variation of the present method provides for determining when a current license can be shared (step 130). Accordingly, when the current license is determined to be shareable (step 135), the present method provides for creating a loaner-license according to the current license to be shared (step 140).

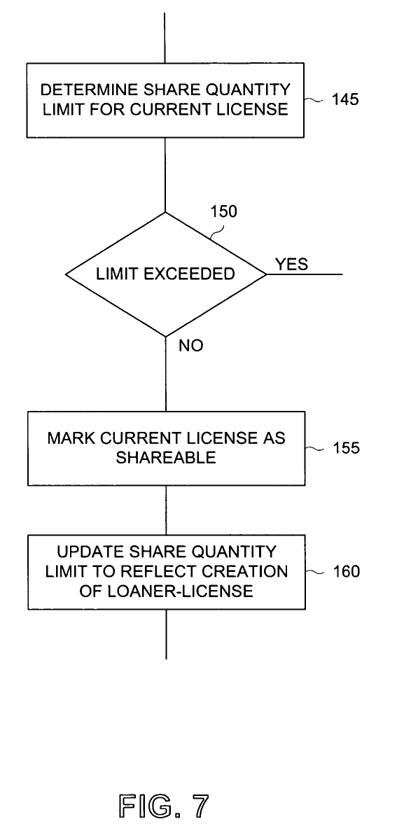

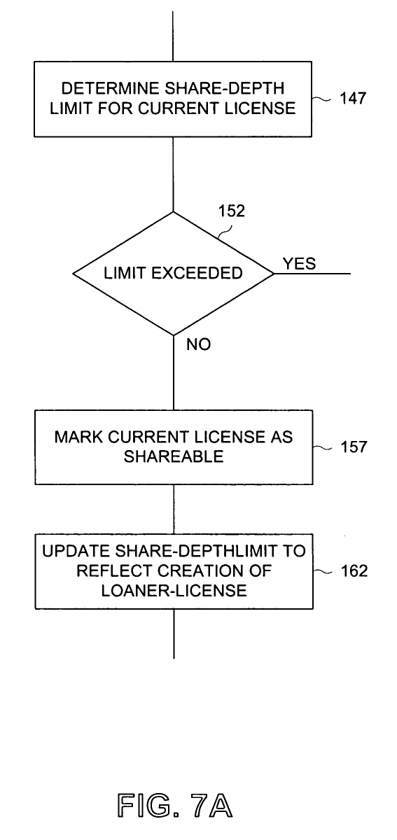

FIG. 7 is a flow diagram that illustrates one alternative method for determining when a current license is shareable according to a share-limit. Typically, the current license will include an indicator as to whether or not it may be shared. It should also be appreciated that a current license may also include an indicator that indicates how frequently the current license can be shared. For example, a current license may include an indicator that indicates that it may be shared only three times. In this situation, the owner user 50 is allowed to share the license once with three other users, three times with a single other user or any combination wherein the total number of shares is less than or equal to three. Accordingly, one example variation of the present method provides for determining a share-quantity limit for a current license (step 145). If the limit is exceeded (step 150), present method provides the current license is no longer shareable. Otherwise, the current license is determined to be shareable (step 155). It should be appreciated that a current license is updated to reflect the fact that a loaner-license has been created. It should also be appreciated that the current license typically includes a limit-count which is updated to reflect the fact that a loaner-license has been created (step 160). According to one variation of the present method, a share-limit indicator included in the current license is incremented and compared to a limit-quantity indicator which is also included in the current license. It should also be appreciated that the current license, according to another variation of the present method, includes a limit-quantity indicator which is decremented every time a loaner-license is created from a current license. In yet another alternative variation of the present method, the limit-quantity indicator is associated with a time period. This supports enforcement for a limit on the number of times a license can be loaned over a particular period of time (e.g. a month). These are merely examples of various methods that can be used to determine a share-quantity limit for a current license and to update the share-quantity limit every time a loaner-license is created. Accordingly, these examples are not intended to limit the scope of the claims appended hereto.

FIG. 7A is a flow diagram that illustrates one alternative method for determining when a current license is shareable according to a share-depth. According to one variation of the present method, determining when a current license can be shared is accomplished by determining a share depth limit for a current license (step 147). When the share depth limit is exceeded (step 152), the current license, which may actually be a loaner-license from the perspective at a borrowing client 35, is said to be non-shareable. Otherwise, the current license is marked as shareable (step 157) and the share depth of a loaner-license created according to the current license is updated to reflect the creation of the loaner-license (step 162). In this variation of the present method, a current license may only be shareable to a particular depth, for example to a depth of 2. This means that a loaner-license conveyed to a borrowing client 35 can also be shared with a third user, wherein the borrowing client 35 creates a loaner-license according to the loaner-license the borrowing client 35 received from the owner client 30. It should be appreciated that the third user will not be able to create a loaner-license which it could then otherwise convey to yet a fourth user unless the share depth in the original owner's license was at least 3. Accordingly, whenever a loaner-license is created, a share-depth indicator included therein is an updated version of a share-depth indicator included in the source license. The share-depth indicator is taken from the source license, for example the original license found in the owner client, and is decremented to reflect the creation of a loaner-license. The decremented value is then included in the loaner-license. Likewise, the borrowing client 35 will typically create an updated (i.e. decremented) share-depth indicator for inclusion in a loaner-license created according to a loaner-license that the borrowing client 35 receives from an owner client 30. The loaner-license created by the borrowing client 35, which includes a now twice decremented (once decremented when the owner client created the first loaner-license and then decremented again when the borrowing client 35 created a loaner-license) share depth indicator, can then be shared with a third user (e.g. a second borrowing client). It should also be appreciated that the limit-quantity indicator, which indicates how frequently a current license can be shared, may need to be updated in a current license, which is maintained in the owner client 30, even when a borrowing client 35 creates a second loaner-license according to a loaner-license it receives from the owner client 30.

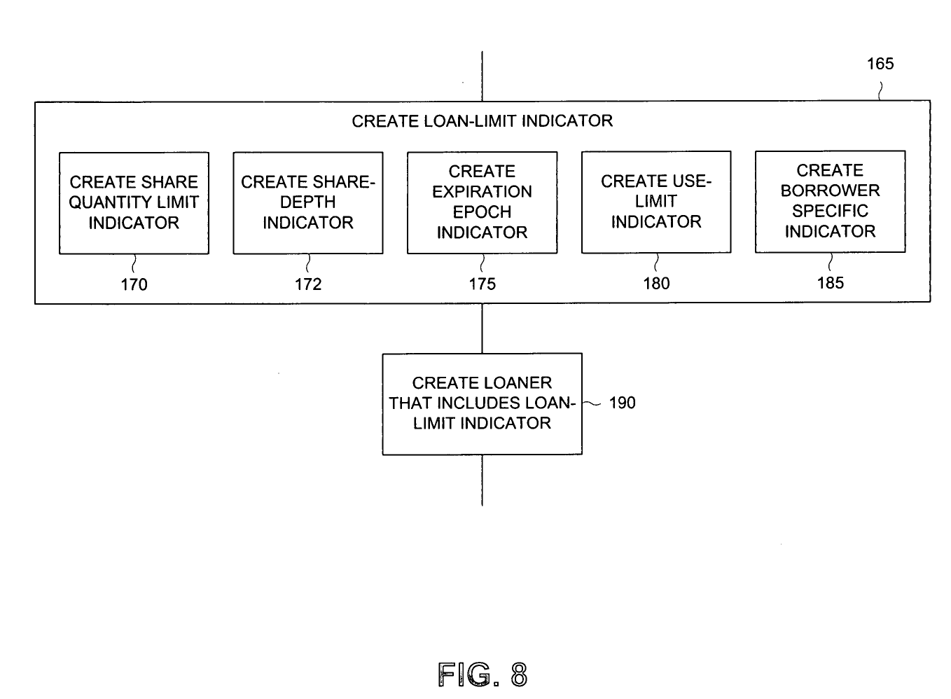

FIG. 8 is a flow diagram that depicts alternative example variations of a method for preparing a loner license that includes a loner-limit indicator. According to one example variations of present method, a loan-limit indicator is created (step 165). A loaner-license that includes the loan-limit indicator is then created according to a current license to be shared (step 190).

It should be appreciated that, according to one variation of the present method, a loan-limit indicator comprises a share-quantity limit indicator (step 170). The share-quantity limit indicator, as discussed above, provides an indication of how many times a current license can be shared. Typically, the share-quantity indicator is created by extracting a share-quantity indicator from a source license (e.g. a current license to be shared maintained in the owner client 30) and decrementing the extracted share-quantity indicator whenever a loaner-license is created according to the current license.

It should be appreciated that, according to one variation of the present method, a loan-limit indicator comprises a share-depth limit indicator (step 172). The share-depth limit indicator, as discussed above, provides an indication as to what extend a current license can be shared by a borrowing client with a second borrowing client. Typically, the share-depth indicator is created by extracting a share-depth indicator from a source license (e.g. a current license to be shared maintained in the owner client 30) and decrementing the extracted share-depth indicator whenever a loaner-license is created according to the current license.

According to yet another variation of the present method, a loan-limit indicator is created by creating an expiration epoch indicator (step 175). It should be appreciated that, according to the sires of an owner user 50, a loaner-license may be temporal in nature. Accordingly, an expiration epoch indicator is created by determining a current time at which a loaner-license is created and then adding to the current time an amount of time for which the loaner-license is to remain valid.

According to yet another example variation of present method, a loan-limit indicator is created by creating to use-limit indicator (step 180). It should be appreciated that an owner user 50 may only wish to allow a borrowing client a limited number of accesses to a particular media file. Accordingly, a use-limit indicator indicates the number of times a loaner-license may be used to access a media file. It should be appreciated that, according to this variation of the present method, a borrowing client 35 may need to relinquish the loaner-license once it has been used a discrete number of times in accordance with the use-limit indicator.

According to yet another example variation of the present method, a loan-limit indicator is created by creating a borrower-specific indicator (step 185). As already discussed supra, a loaner-license may be created specifically for particular borrowing client 35. As such, a borrower-specific indicator, which is typically received from the borrowing client 35, is included as a loan-limit indicator in a loaner-license created according to this variation of the present method.

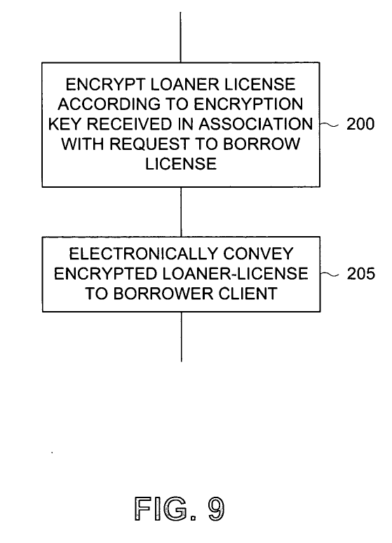

FIG. 9 is a flow diagram that depicts one example method for conveying a loaner-license to a borrowing client in an encrypted manner. As already discussed, a loaner-license may be vulnerable to compromise when it is conveyed to a borrowing client 35. According to one variation of the present method, a loaner-license is encrypted before it is conveyed to the borrowing client 35. According to yet another alternative variation of the present method, the loaner-license is encrypted according to an encryption key received in association with a request to borrow a digital access license (step 200). The encrypted loaner-license is then conveyed electronically to the borrowing client (step 205). It should be appreciated that, according to this variation of the present method, the encryption key received in association with a request to borrow a license is typically received from the borrowing client 35, either directly or through an intermediary (e.g. a license authority 40). Typically, an encryption key received from the borrowing client 35 comprises a public-key which can be used to encrypt the loaner-license. Accordingly, the borrowing client 35 can decrypt the encrypted loaner-license using a private-key which corresponds to the public-key used to encrypt said loaner-license.

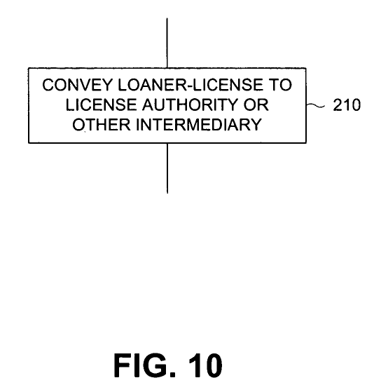

FIG. 10 is a flow diagram that depicts alternative methods for conveying a loaner-license to a borrowing client by means of an intermediary. It should be appreciated that a loaner-license, according to this variation of the present method, is conveyed to a borrowing client by means of at least one of a license authority and an intermediary (step 210). As such, numerous alternative paths can be used to direct to a loner license to a borrowing client. It should be appreciated that an intermediary can include another borrowing client or any other arbitrary device.

FIG. 2 further illustrates that, according to yet another variation of the present method, a content file associated with the current license is also conveyed to the borrowing client 30 (step 25). It should be appreciated that, according to this variation of the present method, the content file typically protected (e.g. encrypted) such that it may be conveyed to the borrowing client 35 without undue exposure to compromise. The borrowing client can then access the content file using the digital access license (i.e. a loaner-license) provided to the borrowing client 35 according to the techniques and teachings of the present method.

FIG. 2 illustrates that, according to yet another example variation of the present method, the current license used as a basis for a loaner-license is marked as “on-loan”. Once a current license is marked as on-loan, it is typically not usable to access a media file until a loaner-license is either relinquished by a borrowing client 35 or expires as a result of a temporal use limit included in the loaner-license. It should also be appreciated that a license for a particular file exhibits a reduced or impaired access capability when it is loaned to another user. It should be appreciated that a borrowing client 35 typically relinquishes a loaner-license when the loaner-license includes a use-limit (e.g. loaner-license is valid for five plays) and the use-limit is exhausted as a result of use of the loaner-license by the borrowing client 35.

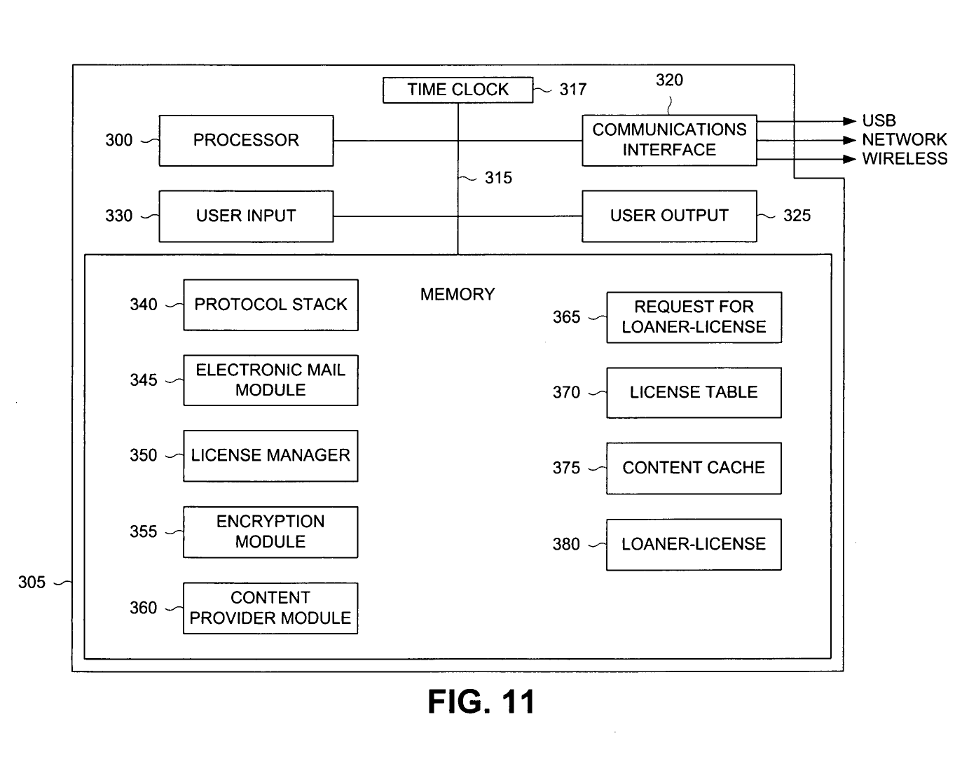

FIG. 11 is a block diagram that depicts several alternative example embodiments of an apparatus for sharing a digital access license. According to one example embodiment, a an apparatus for sharing a digital access license comprises a processor 300, a communications interface 320 and a memory 310. According to one alternative embodiment, an apparatus for sharing a digital access license 305 further comprises a user input device 330 and a user output device 325. In yet another alternative embodiment, the present apparatus 305 further includes a time-clock 317, which maintains a system time or a real-time. These elements are communicatively associated with each other by means of a bus 315.

Various example embodiments of an apparatus for sharing a digital access license 305 as heretofore described further include various functional modules each of which comprises an instruction sequence that can be executed by the processor 300. An instruction sequence that implements a functional module, according to one alternative embodiment, is stored in the memory 310. The reader is advised that the term “minimally causes the processor” and variants thereof is intended to serve as an open-ended enumeration of functions performed by the processor 300 as it executes a particular functional module (i.e. instruction sequence). As such, an embodiment where a particular functional module causes a processor 300 to perform functions in addition to those defined in the appended claims is to be included in the scope of the claims appended hereto.

The functional modules (and their corresponding instruction sequences) described thus far that enable sharing a digital access license are, according to one alternative embodiment, imparted onto computer readable medium. Examples of such medium include, but are not limited to, random access memory, read-only memory (ROM), Compact Disk (CD) ROM, Digital Versatile Disk (DVD), floppy disks, hard disk drives and magnetic tape. This computer readable medium, which alone or in combination can constitute a stand-alone product, can be used to convert a general-purpose computing device into a device for sharing a digital access license wherein said device is capable of sharing a digital access license according to the techniques and teachings presented herein. Accordingly, the claims appended hereto are to include such computer readable medium imparted with such instruction sequences that enable execution of the present method and all of the teachings herein described.

Stored in the memory 310 of this example embodiment are several functional modules including a protocol stack 340 and a license manager 350. According to one alternative illustrative embodiment, an apparatus for sharing a digital access license 305 further includes an electronic mail module 345, which is also stored in the memory 310. In yet another alternative embodiment, an apparatus for sharing a digital access license further comprises an encryption module 355 that is also stored in the memory 310. In yet another alternative embodiment, an apparatus for sharing a digital access license further comprises a content provider module 360. The content provider module 360 of this alternative embodiment is also stored in the memory 310. It should be appreciated that the memory 310 is also used to store information. For example, the memory 310 can, according to various alternative embodiments, be used to store a received request for a loaner-license 365, a license table 370 a content cache 375 and a loaner-license 380 that is being prepared to be conveyed to a borrowing client.

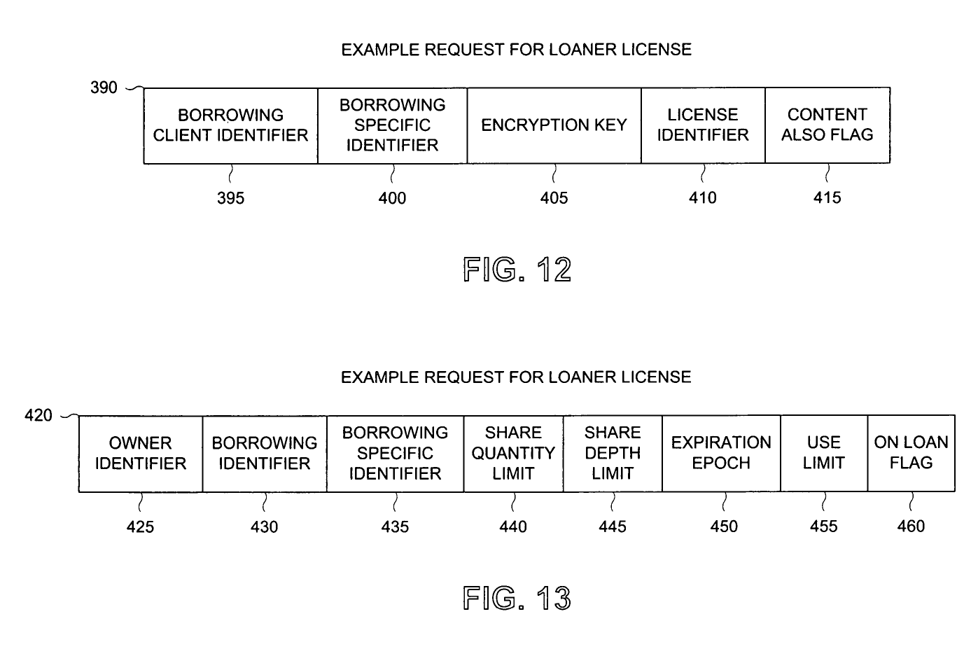

FIG. 12 is a pictorial diagram that illustrates several example embodiments of a request for a loaner-license. According to various example embodiments, a request for a loaner-license 390 comprises a message that includes various fields. According to one alternative embodiment, a request for a loaner-license 390 includes a borrowing client identifier field 395, which is used to store an identifier for a borrowing client 35 that initiated a request for a loaner-license. According to yet another alternative embodiment, the request for a loaner-license 390 further includes a borrower-specific identifier field 400, which is used to store a borrow-specific identifier that can be used to personalize a loaner-license created in response to a request. According to yet another alternative embodiment, a request for a loaner-license 390 further includes an encryption key field 405 that is used to store an encryption key provided by a borrowing client which he be used to encrypt a loner license before it is conveyed to the borrowing client. According to yet another alternative embodiment, the request for a loner license 390 also includes a license identifier field 410, which is used to specify a particular license for which a request for a loner license is intended. In yet another alternative embodiment, the request for a loner license 390 also includes a “content-also” flag 415. A borrowing client can request an owner client to provide a content file along with a loner license by conveyed to the owner client 30 a request for a loner license 390 that includes an active content-also flag.

FIG. 13 is a pictorial diagram that illustrates several example embodiments of a digital access license. According to various alternative embodiments, a digital access license comprises a data structure that is stored either discreetly in the memory 310 or as a record in a license table 370. The format of a current license, i.e. a license that is owned by an owner client 30, and a loaner-license 365, which typically stored discreetly in the memory 310, are substantially equivalent. According to one embodiment, a digital access license 420 includes an owner identifier field 425. The owner identifier field 425 is used to identify an original owner client 32 to which the digital access license was first issued. According to yet another alternative embodiment, a digital access license 420 includes a borrower identifier field 430, which is used to store an identifier of a borrowing client 35 which requested a loner license. In yet another alternative embodiment, a digital access license 420 also includes a borrower-specific identifier field 435. The borrower-specific identifier field 435 is used to personalize a loaner-license prepared for a particular borrowing client 35. Such personalization is intended to prevent unauthorized use of a loaner-license prepared for a borrowing client 35 in response to the request to borrow a loaner-license.

In yet another alternative embodiment, the digital access license 420 includes a share quantity limit field 440. The share quantity limit field 440 is used to store a value that specifies the number of times either an original (e.g. a current) license or a loaner-license can be shared. In yet another alternative embodiment, the digital access license 420 includes a share depth limit field 445. The share depth limit field 445 is used to store a value that specifies the extent to which a loaner-license can be shared with subsequent borrowing clients. According to yet another alternative embodiment, the digital access license 420 includes an expiration epoch field 450. The expiration epoch field 450 is used to store a time at which a loaner-license is to expire. In yet another alternative embodiment, the digital access license 420 includes use-limit field 455. The use-limit field 455 is used to store a value that indicates how many times a loaner-license can be used before it expires (i.e. a play limit). One additional illustrative embodiment of a digital access license further includes an on-loan flag 460. The on-loan flag 460 is used to indicate that a current license (or a loaner-license that is used to create another loaner-license) has been loaned to another user. Typically, a digital access license can not be used to access a media file when the on-loan flag 460 is set.

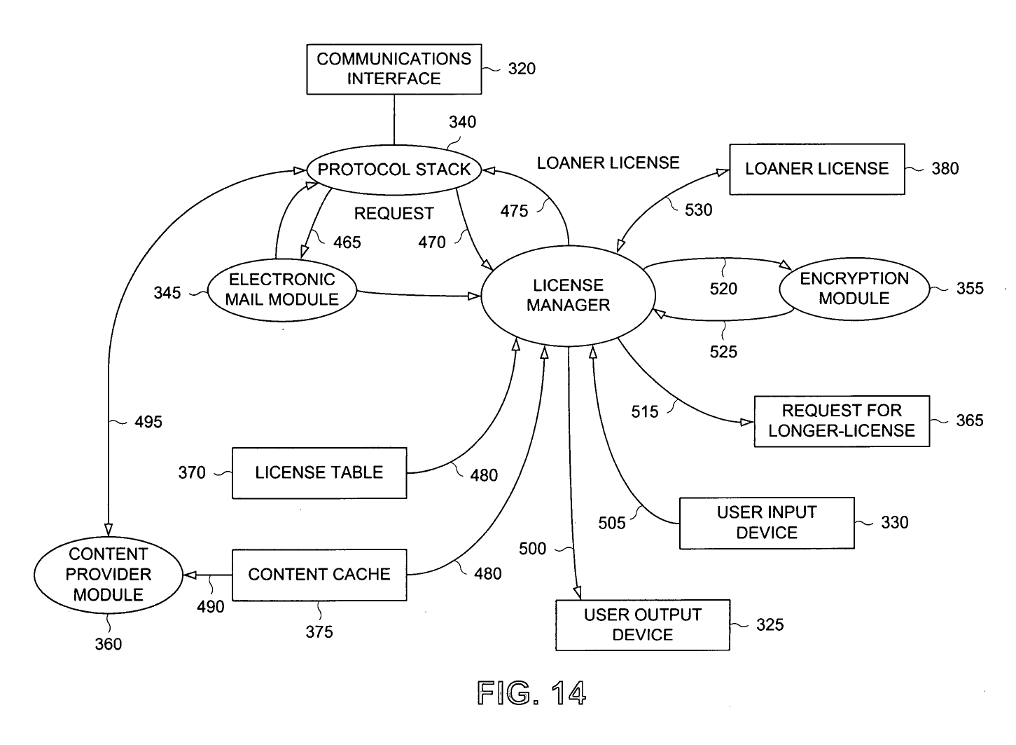

FIG. 14 is a data flow diagram that depicts the internal operation of several alternative embodiments of an apparatus for sharing a digital access license. It should be appreciated that various alternative embodiments of an apparatus for sharing a digital access license 305 include a protocol stack 340. The protocol stack 340, when executed by the processor 300, minimally causes the processor 300 to establishing communications connection with another device by means of the communications interface 320. Typically, the processor 300 uses the protocol stack 340 and order to establish a communications connection that conforms to a particular communications protocol (e.g. TCP/IP). It should be appreciated that various types of protocols can be implemented by a protocol stack 340 and any examples specified herein are intended to illustrate one embodiment of the present apparatus and are not intended to limit the scope of the claims appended hereto. One alternative embodiment of an apparatus for sharing a digital access license 305 includes a license manager 350, which is stored in the memory 310. In this alternative embodiment, the license manager 350, when executed by the processor 300, minimally causes the processor 300 to receive a request to share a digital access license that is stored in the memory 310. Typically, the license manager 350 further minimally causes the processor 300 to store 515 the request for a loaner-license 365 in the memory 310. It should be appreciated that a digital access license that is the subject of a loan request, according to one alternative embodiment, is stored in a license table 370. The license manager 350 of this alternative embodiment further minimally causes the processor 300 to identify a current license stored in the memory 310 according to the received request to share a digital access license. The license manager 350 of this alternative embodiment further minimally causes the processor 300 to prepare a loaner-license according to the identified current license and convey the loaner-license to a connection established by the processor 300 as it executes the protocol stack 340.

In one alternative illustrative embodiment, the license manager 350 causes the processor to receive a request to share a digital access license by minimally causing the processor to execute an electronic mail module 345. When executed by the processor 300, the electronic mail module 340 interacts with the protocol stack 340 to establish a connection with a mail server by means of the communications interface 340. Accordingly, the electronic mail module 345 further minimally causes the processor to receive 465 an electronic mail message. The electronic mail module 345 conveys the electronic mail message to the license manager 350, which further minimally causes the processor 300 to extract a request to share a digital access license from the received electronic mail message. It should be appreciated that the received electronic mail message can be received either from a borrowing client 35 directly or through an intermediary such as a license authority 40.

According to one alternative embodiment, an apparatus for sharing a digital access license 305 include a user input device 330 and the user output device 325. In this alternative embodiment, the license manager 350 further minimally causes the processor to direct 500 to the user output device 325 an indication that the license manager 350 has received 470 a request to share a digital access license. An owner user 50 can acknowledge the request. When the license manager 350 receives 505 an allowance indication from the user input device 330, the license manager 350 further minimally causes the processor to prepare a loaner-license according to a current license which is identified in the license table 370.

According to yet another alternative illustrative embodiment, the license manager 350 causes the processor to receive a request to share a digital access license by minimally causing the processor 300 to receive by means of the communications interface 320 an encryption key. It should be appreciated that the encryption key is typically included in a request for a loner license 390 and is included in an encryption key field 405 included therein. Typically, the encryption key included in a request for a loaner-license comprises a public-key that can be used to encrypt a loaner-license prepared in response to the request.

According to yet another alternative example embodiment, the license manager 350 causes the processor to receive a request to share a digital access license by minimally causing the processor 300 to receive by means of the communications interface 320 a borrower-specific identifier. It should be appreciated that the borrower-specific identifier is typically included in a request for a loner license 390 and is included in a borrower-specific identifier field 400 included therein. Typically, the borrower-specific identifier included in a request for a loaner-license is used to personalize a loaner-license prepared in response to the request.

According to yet another illustrative alternative embodiment, the license manager of 350 of the causes the processor to receive a request to share a digital access license by minimally causing the processor to receive a request to share digital access license by means of the user input device 330. Accordingly, an owner user 50 can issue a request 100 to share a digital access license. As such, this alternative embodiment of the license manager 350, when executed by the processor, minimally causes processor to receive 505 the owner user's 50 request 100 by means of the user input device 330.

According to yet another alternative embodiment, the license manager 350 causes the processor to prepare a loaner-license by minimally causing the processor to determine when a current identified license stored in the memory 310 is shareable. Typically, the license manager 350 minimally causes the processor 300 to retrieve 480 a current identified license from the license table 370. This alternative example embodiment of a license manager 350 further minimally causes the processor 300 to create a loaner-license according to the current identified license stored in the memory 315 once it determines that the current identified license is shareable.

In one example alternative embodiment, the license manager 350, using a current identified license retrieved 480 from the license table 370, minimally causes the processor to determine if a current identified license is shareable by minimally causing the processor 300 to examine a share-quantity limit included in a share quantity limit field 440 included in the current identified license. This alternative embodiment of a license manager 350 causes the processor 300 to note that the current identified license is shareable when the share-quantity limit indicates that the current identified license is shareable. This can be accomplished in a wide variety of manners. For example, the share-quantity limit can be a numeric value that indicates how many times a license can be shared. As such, this alternative embodiment of a license manager 350 updates the share-quantity limit in the current identified license in order reflect the creation of a loaner-license. For example, the processor 300, according to this alternative embodiment, is minimally caused to decrement the share-quantity limit included in the current identified license stored in the license table 370. The decremented value is also reflected in any loaner-license created according to the current identified license.

In yet another example alternative embodiment, the license manager 350, using a current identified license retrieved 480 from the license table 370, minimally causes the processor to determine if a current identified license is shareable by minimally causing the processor 300 to examine a share-depth limit included in a share depth limit field 445 included in the current identified license. This alternative embodiment of a license manager 350 causes the processor 300 to note that the current identified license is shareable when the share-depth limit indicates that the current identified license is shareable. This too can be accomplished in a wide variety of manners. For example, the share-depth limit can be a numeric value that indicates how many times a sub-license can be created based on an instant license. As such, this alternative embodiment of a license manager 350 updates the share-depth limit in a loaner-license created according to the current identified license in order reflect the creation of a loaner-license. For example, the processor 300, according to this alternative embodiment, is minimally caused to decrement the share-depth limit retrieved from the current identified license stored in the license table 370 and to incorporate the decremented value into a newly created loaner-license.

It should be appreciated that, according to one alternative example embodiment of a license manager 350, the license manager 350 causes the processor to prepare a loaner-license by minimally causing the processor to create a loaner-license 380 in the memory 310. As this alternative embodiment of the license manager 350 causes the processor 300 to prepare a loaner-license, it should also be appreciated that, according to one alternative example embodiment of a license manager 350, the license manager 350 causes the processor 300 to create a loan-limit indicator, which can include but is not limited to at least one of a share-quantity limit indicator, a share-depth indicator, and expiration epoch indicator, a use-limit indicator, a frequency limit indicator and a borrower-specific identifier commensurate with the teachings of the present method as heretofore described. The license manager 350 then further minimally causes the processor 300 to include the loan-limit indicator in a loaner-license that it creates according to an identified current license stored in the memory 315, which can be stored as a record in the license table 307. It should further be appreciated that, according to one alternative embodiment, the license manager 350 causes the processor 300 to create an expiration epoch indicator according to a time value received from the time-clock 317.

According to yet another alternative embodiment, the license module 350 causes the processor 300 to convey a loner-license to a borrowing client 35 by minimally causing the processor 300 to execute an encryption module 355. According to this alternative example embodiment, the license manager 350 minimally causes the processor 300 to retrieve a prepared loner-license 380 from the memory 310 and to direct 520 the prepared loner-license to the encryption module 355 along with an encryption key received in association with a request 365 for a loner-license. Accordingly, the encryption module 355, as it is executed by the processor 300, minimally causes the processor 300 to encrypt the prepared loner-license 380 according to the encryption key. The license manager 350 further minimally causes the processor to direct 475 the encrypted loner-license to the protocol stack 340, for example to a communications connection established by the processor 300 as it executes the protocol stack 340.

According to yet another alternative example embodiment, the license manager 350 causes the processor 300 to execute the protocol stack 340 in order to establish a communications connection with a license authority 40 or another arbitrary intermediary. A prepared loner-license 380 is then retrieved 530 from the memory 310 and directed to the communications connection established by the processor 300 with an intermediary or with a license authority 40 as the processor 300 executes the protocol stack 340.

According to one alternative embodiment, an apparatus for sharing a digital access license 305 also includes a content provider module 360 stored in the memory 310. According to this alternative example embodiment, the license manager 350 examines an incoming request for a loner-license, which is typically stored 365 in the memory 310, to determine whether or not the request includes an active “content-also” flag 415. If so, this alternative example embodiment of a license manager 350 further minimally causes the processor 300 to execute the content provider module 360. When executed by the processor 300, the content provider module 360 minimally causes the processor 300 to retrieve 490 a media file from the content cache 375 and to direct 495 the media file to a communications connection established by the processor 300 when it executes the protocol stack 340. Typically, the communications connection is established with a borrower client 35 and is used to affect the conveyance of a media file which is associated with a loner-license prepared in response to the request to borrow a digital access license. It should also be appreciated that, according to yet another alternative example embodiment, the license manager 350 further minimally causes the processor to mark a current identified license as “on-loan”. Accordingly, this alternative embodiment of the license manager 350 causes the processor 300 to update an identified current license stored in the license table 370, for example by setting an “on-loan” flag 460 included in the identified current license.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

1. [claim_M_B]A method for sharing a digital access license comprising:
receiving a request to share a digital access license;
identifying a current license to be shared according to the request;
preparing a loaner license according to the current licensed to be shared; and
conveying the loaner license to a borrowing client.

2. [claim_M_BB]The method of claim 1 wherein receiving a request to share a digital license comprises receiving at least one of an electronic message from the borrowing client and receiving an electronic message from a licensing authority.

3. The method of claim 2 further comprising:
making a local user aware of the request; and
receiving an allow-loan indication from a local user.

4. The method of claim 1 wherein receiving a request to share a digital license comprises receiving at least one of an encryption key and a borrower-specific identifier.

5. The method of claim 1 wherein receiving a request to share a digital license comprises receiving a request to share a license from a local user.

6. [claim_M_BA]The method of claim 1 wherein preparing a loaner license comprises:
determining when the current license can be shared;
creating a loaner license when the current license can be shared.

7. The method of claim 6 wherein determining when the current license can be shared comprises:
determining a share quantity limit for the current license;
marking the current license as sharable when the share quantity limit has not been exceeded; and
updating the share quantity limit for the current license to reflect the creation of a loaner license.

8. The method of claim 6 wherein determining when the current license can be shared comprises:
determining a share depth limit for the current license;
marking the current license as sharable when the share depth limit has not been exceeded; and
updating the share depth limit for the current license to reflect the creation of a loaner license.

9. The method of claim 1 wherein preparing a loaner license comprises:
creating a loan-limit indicator that includes at least one of a share-quantity limit indicator, a share-quantity limit for a time period indicator, a share depth indicator, an expiration epoch indicator, a use-limit indicator and a borrower-specific identifier; and
creating a loaner license that includes the created loan-limit indicator.

10. The method of claim 1 wherein conveying the loaner license comprises:
encrypting the loaner license according to an encryption key received in association with a request to borrow a license; and
electronically conveying the encrypted loaner license to a borrower client.

11. The method of claim 1 wherein conveying the loaner license comprises conveying the loaner license to a license authority.

12. The method of claim 1 further comprising providing a content file which is associated with the current license to the borrowing client.

13. The method of claim 1 further comprising marking the current license as “on-loan”.

14. [claim_A_A]An apparatus for sharing a digital access license comprising:
processor capable of executing an instruction sequence;
communications interface capable of sending and receiving information;
memory capable of storing one or more instruction sequences and further capable of storing information; and
one or more instruction sequences stored in the memory including:
protocol stack that, when executed by the processor, minimally causes the processor to establish a communications connection using the communications interface; and
license manager that, when executed by the processor, minimally causes the processor to:
receive a request to share a digital access license stored in the memory;
identify a current license stored in the memory according to the request to share a digital access license;
execute the protocol stack in order to establish a communications connection;
prepare a loaner-license according to the identified current license; and
convey the loaner-license to the established connection.

15. [claim_A_AA]The apparatus of claim 14 further comprising an electronic mail module stored in the memory that, when executed by the processor, minimally causes the processor to receive an electronic mail message wherein the license manager causes the processor to receive a request to share a digital access license by minimally causing the processor to:
execute the electronic mail module in order to receive an electronic mail message; and
extract a request to share a digital access license from a received electronic mail message when the received electronic mail message is received from at least one of a borrowing client and a licensing authority.

16. The apparatus of claim 15 further comprising a user input unit and a user output unit wherein the license manager further minimally causes the processor to:
direct a message to the user output device according to the received request to share a digital access license; and
receive from the user input device an allowance indicator.

17. The apparatus of claim 14 wherein the license manager causes the processor to receive a request to share a digital access license by minimally causing the processor to receive by means of the communications interface at least one of an encryption key and a borrower-specific identifier.

18. The apparatus of claim 14 further comprising a user input device wherein the license manager causes the processor to receive a request to share a digital access license by minimally causing the processor to receive a request to share a digital access license by means of the user input device.

19. [claim_A_AB]The apparatus of claim 14 wherein the license manager causes the processor to prepare a loaner-license by minimally causing the processor to:
determine when a current identified license stored in the memory is shareable; and
create a loaner-license according to the current identified license stored in the memory when the current identified license is shareable.

20. The apparatus of claim 14 wherein the license module causes the processor to determine when a current license is sharable by minimally causing the processor to:
retrieve a share-quantity limit included in the current identified license to be shared;
note that the current identified license as shareable when the retrieved share-quantity indicator indicates that the current identified license is shareable; and
update the share-quantity limit in the current identified license in order to reflect the creation of a loaner-license.

21. The apparatus of claim 14 wherein the license module causes the processor to determine when a current license is sharable by minimally causing the processor to:
retrieve a share-depth limit included in the current identified license to be shared; and
note that the current identified license as shareable when the retrieved share-depth indicator indicates that the current identified license is shareable.

22. The apparatus of claim 14 wherein the license module causes the processor to prepare a loaner-license by minimally causing the processor to:
create a loan-limit indicator that comprises at least one of a share-quantity limit indicator, a share-quantity for a time period indicator, a share depth indicator, an expiration epoch indicator, a use-limit indicator and a borrower-specific identifier; and
create a loaner-license that includes the loan-limit indicator.

23. The apparatus of claim 14 further comprising an encryption module stored in the memory that, when executed by the processor, minimally causes the processor to encrypt a loaner-license stored in the memory according to an encryption key that is also stored in the memory wherein the license manager causes the processor to convey a loaner-license to a borrowing client by minimally causing the processor to:
execute the encryption module in order to encrypt a loaner-license stored in the memory; and
convey an encrypted loaner-license from the memory to a connection established by the processor when it executed the protocol stack.

24. The apparatus of claim 14 wherein the license manager causes the processor to execute the protocol stack in order to establish a communications connection with a license authority and causes the processor to convey a loaner-license to a borrowing client by minimally causing the processor to direct the loaner-license to the communications connection established with the license authority.

25. The apparatus of claim 14 further comprising a content provider module that, when executed by the processor, minimally causes the processor to provide a content file stored in memory and associated with the loaner-license to a communications connection established by the processor when it executed the protocol stack and wherein the license manager further minimally causes the processor to execute the content provider module.

26. The apparatus of claim 14 wherein the license manager further minimally causes the processor to mark a current identified license as “on-loan”.
